(19) United States
(12) Patent Application Publication
(10) Pub. No.: US 2025/0159255 A1
(43) Pub. Date: May 15, 2025

(54) METHOD TO ENCODE SYMMETRIC SUBMESHES VIA TRANSFORMATION

(71) Applicant: TENCENT AMERICA LLC, Palo Alto, CA (US)

(72) Inventors: Pranav KADAM, Palo Alto, CA (US); Thuong NGUYEN CANH, Palo Alto, CA (US); Xiaozhong XU, State College, PA (US); Shan LIU, San Jose, CA (US)

(73) Assignee: TENCENT AMERICA LLC, Palo Alto, CA (US)

(21) Appl. No.: 18/903,608

(22) Filed: Oct. 1, 2024

Related U.S. Application Data
(60) Provisional application No. 63/548,472, filed on Nov. 14, 2023.

(51) Int. Cl. H04N 19/597; G06T 17/20

(52) U.S. Cl. CPC H04N 19/597; G06T 17/20

(57) ABSTRACT

A method and apparatus comprising computer code for mesh coding. The method may include partitioning an input mesh into a symmetric mesh and an asymmetric mesh using a global symmetry plane. Then, determine one or more sub-meshes in the asymmetric mesh, and for each sub-mesh in the asymmetric mesh, the method may include determining whether the respective sub-mesh is symmetric. Based on the determination that a sub-mesh is symmetric, the method may include determining a symmetry plane for the respective sub-mesh and determining transformation information for the first sub-mesh. The transformation information is used for aligning the symmetry plane of the first sub-mesh with the global symmetry plane. The method may also include signaling the transformation information.

### CROSS REFERENCE TO RELATED APPLICATION

The present application claims priority to U.S. Provisional Application No. 63/548,472, filed on Nov. 14, 2023, the disclosure of which is incorporated herein in its entirety.

### FIELD

Embodiments of this disclosure are directed to video coding and decoding. Specifically, embodiments of the present disclosure are to encoding and decoding method to compress symmetric submeshes that have different symmetry planes than the global symmetry plane.

### BACKGROUND

Advanced three-dimensional (3D) representations of the world are enabling more immersive forms of interaction and communication. To achieve realism in 3D representations, 3D models are becoming ever more sophisticated, and a significant amount of data is linked to the creation and consumption of these 3D models. 3D meshes are widely used to 3D model immersive content.

A 3D mesh may include several polygons that describe the surface of a volumetric object. A dynamic mesh sequence may require a large amount of data since it may have a significant amount of information changing over time. Therefore, efficient compression technologies are required to store and transmit such contents.

While mesh compression standards IC, MESHGRID, FAMC were previously developed to address dynamic meshes with constant connectivity and time varying geometry and vertex attributes. However, these standards do not take into account time varying attribute maps and connectivity information.

Furthermore, it is also challenging for volumetric acquisition techniques to generate a constant connectivity dynamic mesh, especially under real time constraints. This type of dynamic mesh content is not supported by the existing standards.

As another example, glTF (GL Transmission Format) is standard being developed from the Khronos Group for the efficient transmission and loading of 3D scenes and models by applications. glTF aims to minimize both the size of 3D assets, and the runtime processing needed to unpack. A geometry compression extension to glTF 2.0 using Google Draco technology is being developed to reduce the size of glTF models and scenes.

### SUMMARY

According to an embodiment, a method for compression is provided. The method may include partitioning an input mesh into a symmetric mesh and an asymmetric mesh using a global symmetry plane; determining one or more sub-meshes in the asymmetric mesh; for a first sub-mesh in the asymmetric mesh, determining whether the first sub-mesh is symmetric; determining a symmetry plane for the first sub-mesh when the first sub-mesh is symmetric; determining transformation information for the first sub-mesh, wherein the transformation information is used for aligning the symmetry plane of the first sub-mesh with the global symmetry plane; and signaling the transformation information.

According to an embodiment, an apparatus for mesh compression is provided. The apparatus may include at least one memory configured to store program code; and at least one processor configured to read the program code and operate as instructed by the program code. The program code may include partitioning code configured to cause the at least one processor to partition an input mesh into a symmetric mesh and an asymmetric mesh using a global symmetry plane; first determining code configured to cause the at least one processor to determine one or more sub-meshes in the asymmetric mesh; second determining code configured to cause the at least one processor to determine, for a first sub-mesh in the asymmetric mesh, whether the first sub-mesh is symmetric; third determining code configured to cause the at least one processor to determine a symmetry plane for the first sub-mesh when the first sub-mesh is symmetric; fourth determining code configured to cause the at least one processor to determine transformation information for the first sub-mesh, wherein the transformation information is used for aligning the symmetry plane of the first sub-mesh with the global symmetry plane; and first signaling code configured to cause the at least one processor to signal the transformation information.

According to an embodiment, a non-transitory computer-readable medium storing instructions is provided. The instructions may include: one or more instructions that, when executed by one or more processors of a device for mesh coding, cause the one or more processors to partition an input mesh into a symmetric mesh and an asymmetric mesh using a global symmetry plane; determine one or more sub-meshes in the asymmetric mesh; for a first sub-mesh in the asymmetric mesh, determine whether the first sub-mesh is symmetric; determine a symmetry plane for the first sub-mesh when the first sub-mesh is symmetric; determine transformation information for the first sub-mesh, wherein the transformation information is used for aligning the symmetry plane of the first sub-mesh with the global symmetry plane; and signal the transformation information.

### BRIEF DESCRIPTION OF THE DRAWINGS

Further features, nature, and various advantages of the disclosed subject matter will be more apparent from the following detailed description and the accompanying drawings in which:

FIG. 1 is a schematic illustration of a simplified block diagram of a communication system, in accordance with embodiments of the present disclosure.

FIG. 2 is a schematic illustration of a simplified block diagram of a streaming system, in accordance with embodiments of the present disclosure.

FIG. 3 is a schematic illustration of a simplified block diagram of a video encoder and decoder, in accordance with embodiments of the present disclosure.

FIG. 4 is a schematic illustration of a simplified block diagram of processing performed on an input mesh, in accordance with embodiments of the present disclosure.

FIG. 5 illustrates an exemplary mesh and sub-mesh partition, in accordance with embodiments of the present disclosure.

FIG. 6 illustrates a transformation for aligning a sub-mesh with a global symmetry plane, in accordance with embodiments of the present disclosure.

FIG. 7 is a flowchart of a process for mesh compression, in accordance with embodiments of the present disclosure.

FIG. 8 is an exemplary diagram of a computer system suitable for implementing embodiments.

### DETAILED DESCRIPTION

The proposed features discussed below may be used separately or combined in any order. Further, the embodiments may be implemented by processing circuitry (e.g., one or more processors or one or more integrated circuits). In one example, the one or more processors execute a program that is stored in a non-transitory computer-readable medium.

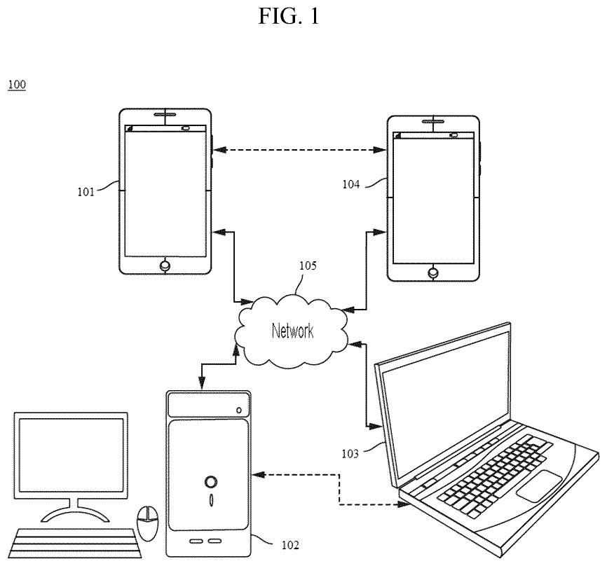

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

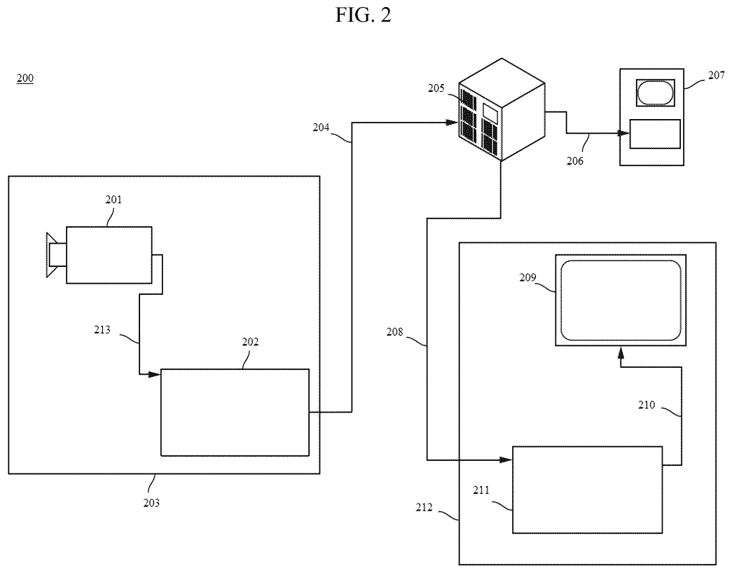

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the video source 201, which may be for example a camera as discussed above. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

According to exemplary embodiments further described below, the term “mesh” indicates a composition of one or more polygons that describe the surface of a volumetric object. Each polygon is defined by its vertices in 3D space and the information of how the vertices are connected, referred to as connectivity information. Optionally, vertex attributes, such as colors, normals, etc., could be associated with the mesh vertices. Attributes could also be associated with the surface of the mesh by exploiting mapping information that parameterizes the mesh with 2D attribute maps. Such mapping may be described by a set of parametric coordinates, referred to as UV coordinates or texture coordinates, associated with the mesh vertices. 2D attribute maps are used to store high resolution attribute information such as texture, normals, displacements etc. Such information could be used for various purposes such as texture mapping and shading according to exemplary embodiments.

Nonetheless, a dynamic mesh sequence may require a large amount of data since it may consist of a significant amount of information changing over time. For example, in contrast to a “static mesh”, or “static mesh sequence,” in which information of that mesh may not change from one frame to another, a “dynamic mesh”, or a “dynamic mesh sequence”, indicates motion in which ones of vertices represented by that mesh change from one frame to another. Therefore, efficient compression technologies are required to store and transmit such contents. Mesh compression standards IC, MESHGRID, FAMC were previously developed by MPEG to address dynamic meshes with constant connectivity and time varying geometry and vertex attributes. However, these standards do not take into account time varying attribute maps and connectivity information. DCC (Digital Content Creation) tools usually generate such dynamic meshes. In counterpart, it is challenging for volumetric acquisition techniques to generate a constant connectivity dynamic mesh, especially under real time constraints. This type of contents is not supported by the existing standards. According to exemplary embodiments herein, there is described aspects of a new mesh compression standards to directly handle dynamic meshes with time varying connectivity information and optionally time varying attribute maps, this standard targets lossy, and lossless compression for various applications, such as real-time communications, storage, free viewpoint video, AR and VR. Functionalities such as random access and scalable/progressive coding are also considered.

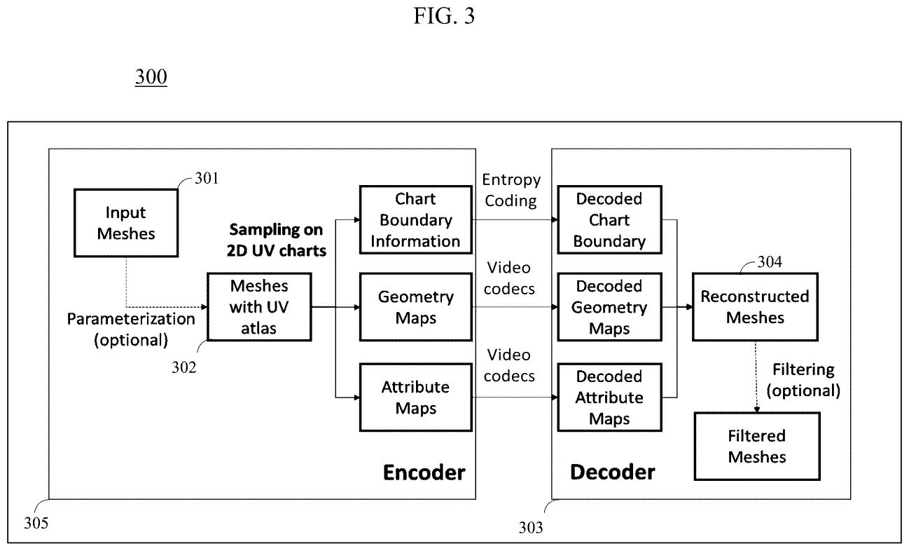

FIG. 3 represents an example framework 300 of dynamic mesh compression such as for a 2D atlas sampling based method. Each frame of the input meshes 301 can be preprocessed by a series of operations, e.g., tracking, remeshing, parameterization, voxelization. Note that, these operations can be encoder-only, meaning they might not be part of the decoding process and such possibility may be signaled in metadata by a flag such as indicating 0 for encoder only and 1 for other. After that, one can get the meshes with 2D UV atlases 302, where each vertex of the mesh has one or more associated UV coordinates on the 2D atlas. Then, the meshes can be converted to multiple maps, including the geometry maps and attribute maps, by sampling on the 2D atlas. Then these 2D maps can be coded by video/image codecs, such as HEVC, VVC, AV1, AVS3, etc. On the decoder 303 side, the meshes can be reconstructed from the decoded 2D maps. Any post-processing and filtering can also be applied on the reconstructed meshes 304. Note that other metadata might be signaled to the decoder side for the purpose of 3D mesh reconstruction. Note that the chart boundary information, including the uv and xyz coordinates, of the boundary vertices can be predicted, quantized and entropy coded in the bitstream. The quantization step size can be configured in the encoder side to tradeoff between the quality and the bitrates.

In some implementations, a 3D mesh can be partitioned into several segments (or patches/charts), one or more 3D mesh segments may be considered to be a “3D mesh” according to exemplary embodiments. Each segment is composed of a set of connected vertices associated with their geometry, attribute, and connectivity information.

Dual Degree mesh coding is a specialized technique aimed at efficiently encoding and decoding the connectivity of polygon meshes. Through the principle of duality, dual degree mesh coding enables encoding and decoding connectivity data of sub-meshes by constructing two separate sequences: one characterizing the valence of vertices and the other depicting the degrees of faces.

In accordance with a standard in the art, a mesh consists of the following components: connectivity information; geometry information; mapping information; vertex attributes; and attribute maps.

Connectivity information is a set of vertex indices describing how to connect the mesh vertices to create a 3D surface. Geometry and all the attributes share the same unique connectivity information.

Geometry information is described by a set of 3D positions associated with the mesh vertices. The (x,y,z) coordinates describing the positions should have finite precision and dynamic range.

Mapping information describes how to map the mesh surface to 2D regions of the plane. Such mapping is described by a set of UV parametric/texture coordinates associated with the mesh vertices together with the connectivity information. The texture coordinates have finite precision and dynamic range.

Vertex attributes are scalar or vector attribute values associated with the mesh vertices. The attributes values have finite precision and dynamic range.

Attribute maps are attributes associated with the mesh surface and stored as 2D images/videos. The mapping between the videos (i.e., parametric space) and the surface is defined by the mapping information.

A dynamic mesh is a mesh where at least one of the five components is varying in time. An animated mesh is a dynamic mesh with constant connectivity.

Mesh geometry information consists of vertex connectivity information, 3D coordinates, and 2D texture coordinates, etc. The compression of vertex 3D coordinates, which is also called vertex position, is very important, as in most cases, it takes up significant portion of the entire geometry related data.

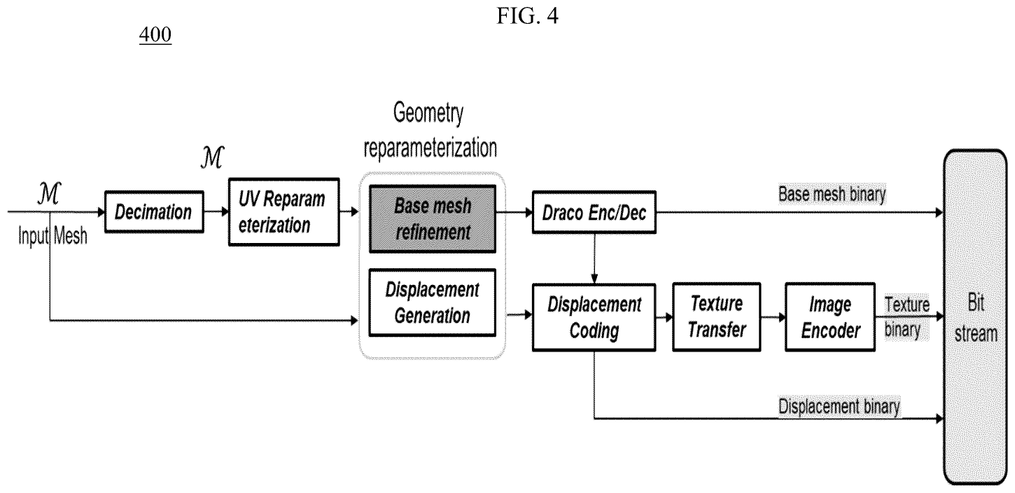

FIG. 4 illustrates a mesh encoding process 400.

VMesh is an ongoing MPEG standard to compress dynamic meshes. The VMesh standard at present, as illustrated in FIG. 4, compresses meshes based on decimated base meshes (that may be encoded then encoded by known techniques, e.g., by Draco), displacements coding and motion fields (in embodiments). The displacements vectors and displacement coding generally are calculated by searching the closest point on the input mesh with respect to each vertex of the subdivided based mesh. To encode the displacement, displacements vectors are transformed into wavelet coefficients, e.g., by the linear lifting scheme, and then the coefficients are quantized and coded by a video codec or arithmetic codec. The process as shown in FIG. 4 also refines the base mesh to minimize the displacement. Texture transfer is performed to match the texture with reparametrized geometry and UV as well as optimized texture for image compression.

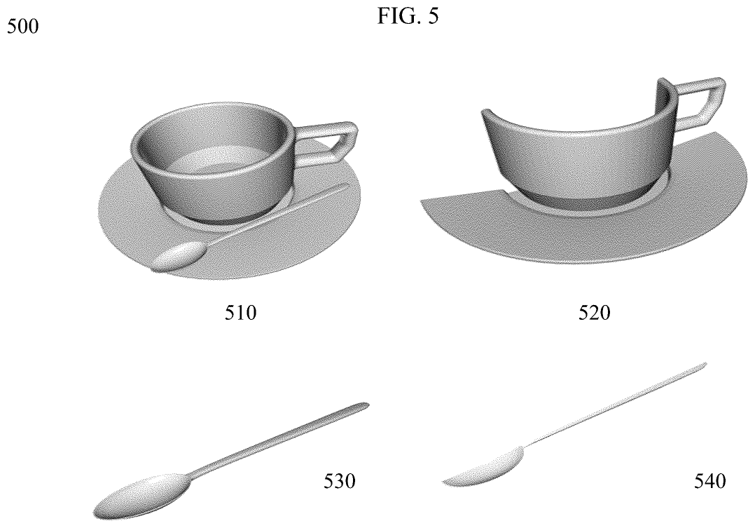

Reflection symmetry is a characteristic of meshes, especially computer generated meshes. Symmetry was utilized to compress symmetry mesh. In embodiments, vertices are divided into left and right part of the symmetry plane (as shown in diagrams 510 and 520 of FIG. 5). The left part may be encoded by mesh coding while the right part may be encoded by a symmetry prediction and displacement coding. Even though the texture coordinate (or UV attribute) also has a certain level of symmetry, that symmetry can be a different symmetry property like transition and rotation. This different symmetry property and properties associated with texture coordinate compression for symmetry mesh have not been exploited yet.

Generally, while meshes have some reflection symmetry, many meshes do not possess reflection symmetry for the entire mesh. Sometimes only a part of the mesh maybe symmetric or different parts of a mesh may exhibit different local symmetries. This local symmetry is not exploited yet. Existing symmetry coding tools with single global symmetry plane don't account for local symmetries which may exist in sub-meshes.

It may be understood that the proposed methods may be used separately or combined in any order and may be used for arbitrary polygon meshes. In this disclosure mesh is assumed to be fully or partially symmetric in geometry. Symmetry coding is used for half mesh (e.g., the left mesh), which is then used to predict the remainder mesh (e.g., the right mesh).

According to an embodiment of the disclosure, a rigid transformation is determined which aligns a symmetric sub-mesh with the global symmetric plane of the mesh. Symmetric coding tools may be for encoding the sub-mesh. The method assumes that for a symmetric mesh M, a global symmetry plane p is already found and the mesh is divided into symmetric part M_{sym} and asymmetric part M_{asym}. As an example, diagram 510 illustrates an input mesh which has some reflection symmetry and diagram 520 illustrates a left mesh of the input mesh slit according to the global symmetry plane.

In an embodiment, the sub-meshes of the asymmetric part M_{asym} are extracted. Then, For each sub-mesh M_{asym}ⁱ, whether the sub-mesh exhibits reflection symmetry is checked and a symmetry plane p_{asym}ⁱ is estimated. As an example, diagram 530 illustrates an asymmetric mesh, which includes a symmetric sub-mesh such as diagram 530. Diagram 540 illustrates a left-side split of the symmetric sub-mesh such as diagram 530 split according to its symmetry plane.

In embodiments of the present disclosure, a rigid transformation that aligns sub-mesh symmetry plane p_{asym}ⁱ with global symmetry plane p is determined. The rigid transformation may be obtained by aligning normal of the two planes to make them parallel followed by translating the second plane to overlap with the first.

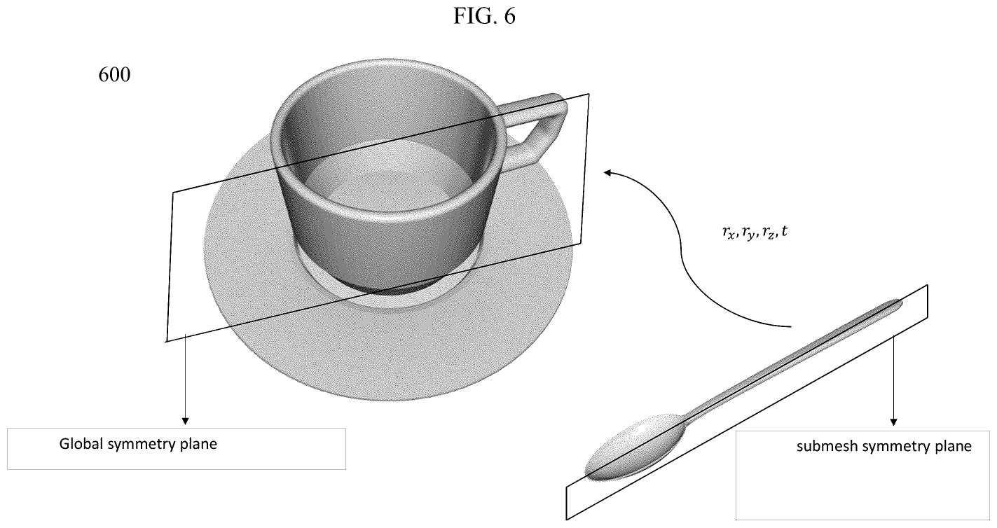

According to an embodiment, a symmetric sub-mesh from the asymmetric part M_{asym} may be aligned with the symmetric part M_{sym} using transformations corresponding to symmetric sub-meshes. The transformation which aligns the sub-mesh symmetric plane p_{asym}ⁱ and global symmetric plane p may be expressed as a rotation component given by three Euler angles rₓ, r_{y}, r_{z}. The rotation component may help transform p_{asym}ⁱ to make it parallel to p. A one-dimensional translation component t may be determined to move the transformed plane to overlap with p. The vertices of the symmetric submesh are transformed using this transformation. These symmetric sub-meshes will now be a part of M_{sym} and removed from M_{asym}. An exemplary transformation is illustrated in FIG. 6.

According to embodiments of the present disclosure, the process of recovering the pose of the sub-mesh is disclosed. Using a symmetric coding tool, M_{sym} may be reconstructed using its symmetry plane and left half mesh. The sub-mesh ID from the bitstream may be used to identify the sub-mesh to be transformed back along with the necessary transformation parameters. To decode the sub-mesh, the negative of the translation component may be used to translate the sub-mesh back along the normal direction. Then, the inverse rotation components may be found as the inverse of the rotation matrix and applied to sub-mesh vertices to recover the correct pose of the sub-mesh.

A plurality of signaling schemes are described herein.

According to an embodiment, a signalling scheme to encode the transformation information may consist of signalling the number of sub-meshes with transformation; followed by, for each sub-mesh, signalling the sub-mesh ID in M_{sym}, three rotation parameters and one translation parameter.

TABLE 1
Signaling Scheme

| | |
|---|---|
| submesh_symmetry_transformation_set( ) { | |
| num_submeshes_with_transformation | u(b₁) |
| for (i = 1; i <= num_submeshes_with_transformation; i++) { | |
| submesh_ID | u(b₂) |
| translation[i] | i(b₁) |
| for(j = 0; j < 3; j++ ) { | |
| rotation[i][j] | i(b₂) |
| } | |
| } | |
| } | |

Where, u(n) is unsigned integer using n bits and i(n) is integer using n bit. IN Table 1, rotation is the 2D array that stores rotation components; rotation[i][j] is the j-th rotation component for the i-th sub-mesh; translation is the 1D array that stores translations; translation[i] is the translation for the i-th sub-mesh; num_submeshes_with_transformation is the number of sub-meshes for which transformation needs to be encoded; and submesh_ID is the index of the sub-mesh the transformation corresponds to.

According to an embodiment, a reduced signaling cost may use a signaling scheme for transformation based on specific type of transform. It is known that many symmetric planes are parallel to unit planes, or cardinal planes, e.g., XY, YZ, XZ planes. Using this knowledge, transformation may only need 2 bits to indicate the unit plane, and one parameter for the one-dimensional transition.

Transformation may be signaled following the encoding order of sub-mesh, or the order of vertex, face numbers, etc. Decoder can derive the corresponding sub-mesh. Therefore, submesh_ID may be obmitted.

TABLE 2
Signaling Scheme With Reduced Signaling Cost

| | |
|---|---|
| submesh_symmetry_transformation_set( ) { | |
| num_submeshes_with_transformation | u(b₁) |
| for (i = 1; i <= num_submeshes_with_transformation; i++) { | |
| transition_only_flag | b(1) |
| if (trainsition_only_flag) { | |
| parallel_sym_trans_flag | b(1) |
| if (parallel_sym_trans_flag) { | |
| parallel_plane_index | b(2) |
| translation_offset | i(b₁) |
| } else { | |
| translation[i] | i(b₁) |
| } else { | |
| for(j = 0; j < 3; j++ ) { | |
| rotation[i][j] | i(b₂) |
| } | |
| } | |
| } | |

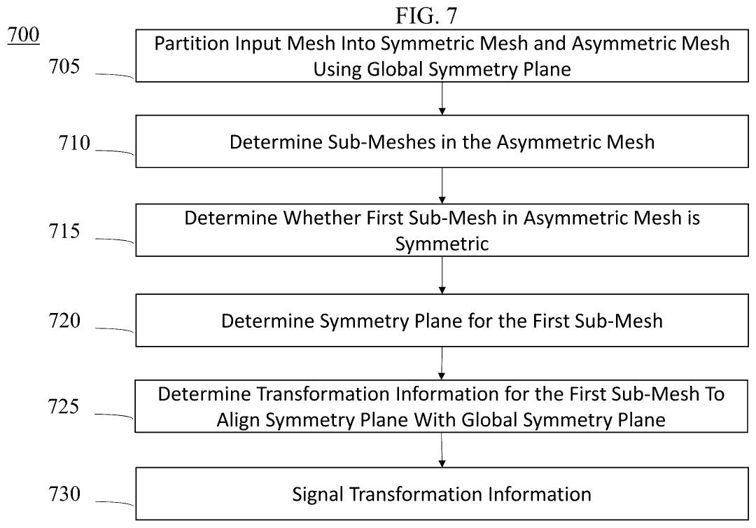

FIG. 7 illustrates a mesh compression process 700 for mesh compression.

Operation 705 may include partitioning an input mesh into a symmetric mesh and an asymmetric mesh using a global symmetry plane.

Operation 710 may include determining one or more sub-meshes in the asymmetric mesh. As an example, it may be determined if the asymmetric mesh includes a symmetric sub-mesh such as the one shown in diagram 530.

Operation 715 may include determining, for a first sub-mesh in the asymmetric mesh, whether the first sub-mesh is symmetric.

Operation 720 may include determining a symmetry plane for the first sub-mesh when the first sub-mesh is symmetric. As an example, it may be determined if the sub-mesh shown in diagram 530 is symmetric along a symmetry plane.

Operation 725 may include determining transformation information for the first sub-mesh, with the transformation information being used for aligning the symmetry plane of the first sub-mesh with the global symmetry plane. As an example, transformation information may be determined that enables alignment as shown in FIG. 6.

In embodiments, the transformation information may include a rotation component that includes three Euler angles; and a translation component that indicates a distance for moving the symmetry plane of the first sub-mesh to the global symmetry plane.

In embodiments, when the symmetry plane of the first sub-mesh is parallel to a cardinal plane, the transformation information may include parallel plane index that indicates whether the symmetry plane of the first sub-mesh is parallel to XY plane, YZ plane, or XZ plane and a translation component that includes a distance for moving the symmetry plane of the first sub-mesh to the global symmetry plane.

Operation 730 may include signaling the transformation information.

In embodiments, the signaling may include signaling a number of sub-meshes that have associated transformation information; signaling, for each sub-mesh that has associated transformation information, a sub-mesh ID in the symmetric mesh; and signaling the transformation information.

In embodiments, the transformation information may be signaled in an encoding order; an order of encoding vertices; or an order of face numbers of sub-meshes.

In embodiments, the first sub-mesh may be coded as a part of the symmetric mesh instead of the asymmetric mesh.

In embodiments, when the transformation information is signaled in the order, a sub-mesh ID of a sub-mesh that has associated transformation information is not signaled.

It may be understood that while process 700 is described with respect to a first sub-mesh, a person of skill in the art will know that process 700 may be applied to all symmetric sub-meshes in the asymmetric mesh or may only be applied to a subset of such sub-meshes.

It may be understood that the process 700 may describe an encoding process, but a person of skill in the art will know that similar operations may be performed in a modified order for a decoding process.

The proposed methods may be used separately or combined in any order. The proposed methods may be used for arbitrary polygon mesh, but even though only a triangle mesh may have been used for demonstration of various embodiments. As noted above, it will be assumed that an input mesh may contain one or multiple instances, that a sub-mesh is a part of input mesh with an instance or multiple instances, and that multiple instances can be grouped to form a sub-mesh.

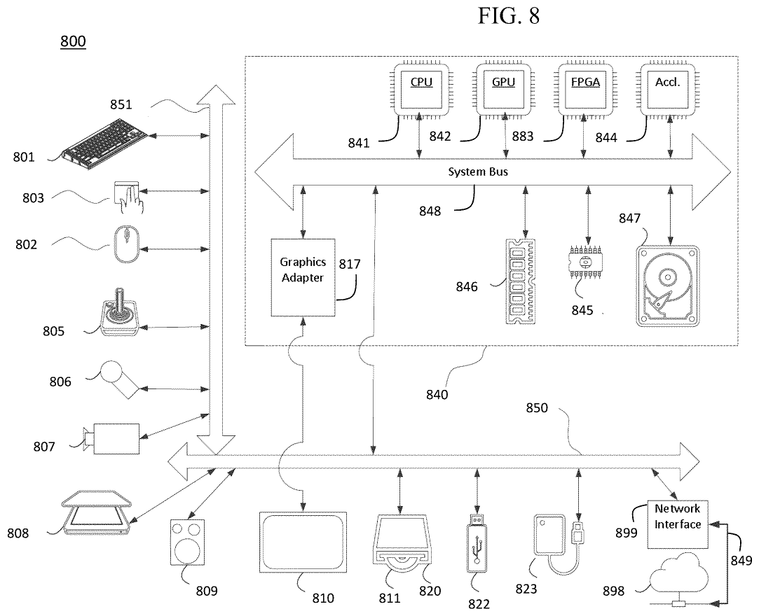

The techniques described above, can be implemented as computer software using computer-readable instructions and physically stored in one or more computer-readable media or by a specifically configured one or more hardware processors. For example, FIG. 8 shows a computer system 800 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 8 for computer system 800 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 800.

Computer system 800 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 801, mouse 802, trackpad 803, touch screen 810, joystick 805, microphone 806, scanner 808, camera 807.

Computer system 800 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 810, or joystick 805, but there can also be tactile feedback devices that do not serve as input devices), audio output devices (such as: speakers 809, headphones (not depicted)), visual output devices (such as screens 810 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 800 can also include human accessible storage devices and their associated media such as optical media including CD/DVD ROM/RW 820 with CD/DVD 811 or the like media, thumb-drive 822, removable hard drive or solid state drive 823, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 800 can also include interface 899 to one or more communication networks 898. Networks 898 can for example be wireless, wireline, optical. Networks 898 can further be local, wide-area, metropolitan, vehicular and industrial, real-time, delay-tolerant, and so on. Examples of networks 898 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 898 commonly require external network interface adapters that attached to certain general-purpose data ports or peripheral buses (750 and 851) (such as, for example USB ports of the computer system 800; others are commonly integrated into the core of the computer system 800 by attachment to a system bus as described below (for example Ethernet interface into a PC computer system or cellular network interface into a smartphone computer system). Using any of these networks 898, computer system 800 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 840 of the computer system 800.

The core 840 can include one or more Central Processing Units (CPU) 841, Graphics Processing Units (GPU) 842, a graphics adapter 817, specialized programmable processing units in the form of Field Programmable Gate Areas (FPGA) 843, hardware accelerators for certain tasks 844, and so forth. These devices, along with Read-only memory (ROM) 845, Random-access memory 846, internal mass storage such as internal non-user accessible hard drives, SSDs, and the like 847, may be connected through a system bus 848. In some computer systems, the system bus 848 can be accessible in the form of one or more physical plugs to enable extensions by additional CPUs, GPU, and the like. The peripheral devices can be attached either directly to the core's system bus 848, or through a peripheral bus 849. Architectures for a peripheral bus include PCI, USB, and the like.

CPUs 841, GPUs 842, FPGAs 843, and accelerators 844 can execute certain instructions that, in combination, can make up the aforementioned computer code. That computer code can be stored in ROM 845 or RAM 846. Transitional data can be also be stored in RAM 846, whereas permanent data can be stored for example, in the internal mass storage 847. Fast storage and retrieval to any of the memory devices can be enabled through the use of cache memory, that can be closely associated with one or more CPU 841, GPU 842, mass storage 847, ROM 845, RAM 846, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 800, and specifically the core 840 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 840 that are of non-transitory nature, such as core-internal mass storage 847 or ROM 845. The software implementing various embodiments of the present disclosure can be stored in such devices and executed by core 840. A computer-readable medium can include one or more memory devices or chips, according to particular needs. The software can cause the core 840 and specifically the processors therein (including CPU, GPU, FPGA, and the like) to execute particular processes or particular parts of particular processes described herein, including defining data structures stored in RAM 846 and modifying such data structures according to the processes defined by the software. In addition or as an alternative, the computer system can provide functionality as a result of logic hardwired or otherwise embodied in a circuit (for example: accelerator 844), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.

(1) A method of mesh encoding and/or decoding, the method including partitioning an input mesh into a symmetric mesh and an asymmetric mesh using a global symmetry plane; determining one or more sub-meshes in the asymmetric mesh; for a first sub-mesh in the asymmetric mesh, determining whether the first sub-mesh is symmetric; determining a symmetry plane for the first sub-mesh when the first sub-mesh is symmetric; determining transformation information for the first sub-mesh, wherein the transformation information is used for aligning the symmetry plane of the first sub-mesh with the global symmetry plane; and signaling the transformation information.

(2) The method of feature (1), in which the transformation information includes a rotation component, wherein the rotation component comprises three Euler angles; and a translation component, wherein the translation component comprises a distance for moving the symmetry plane of the first sub-mesh to the global symmetry plane.

(3) The method of any of the features of (1) to (2), in which the method further comprises coding the first sub-mesh as a part of the symmetric mesh instead of the asymmetric mesh.

(4) The method of any of the features of (1) to (3), in which the signaling the transformation information includes signaling a number of sub-meshes that have associated transformation information; signaling, for each sub-mesh that has associated transformation information, a sub-mesh ID in the symmetric mesh; and signaling the transformation information.

(5) The method of any of the features of (1) to (4), in which when the symmetry plane of the first sub-mesh is parallel to a cardinal plane, the transformation information includes parallel plane index that indicates whether the symmetry plane of the first sub-mesh is parallel to XY plane, YZ plane, or XZ plane; and a translation component, wherein the translation component comprises a distance for moving the symmetry plane of the first sub-mesh to the global symmetry plane.

(6) The method of any of the features of (1) to (5), in which the transformation information is signaled in an order according to one of an encoding order; an order of encoding vertices; or an order of face numbers of sub-meshes.

(7) The method of any of the features of (1) to (6), in which when the transformation information is signaled in the order, a sub-mesh ID of a sub-mesh that has associated transformation information is not signaled.

(8) An apparatus for mesh coding, including processing circuitry that is configured to perform the method of any of features (1) to (7).

(9) A non-transitory computer-readable storage medium storing instructions which when executed by at least one processor cause the at least one processor to perform the method of any of features (1) to (7).

What is claimed is:

1. A method for mesh coding, the method being executed by at least one processor, the method comprising:
partitioning an input mesh into a symmetric mesh and an asymmetric mesh using a global symmetry plane;
determining one or more sub-meshes in the asymmetric mesh;
for a first sub-mesh in the asymmetric mesh, determining whether the first sub-mesh is symmetric;
determining a symmetry plane for the first sub-mesh when the first sub-mesh is symmetric;
determining transformation information for the first sub-mesh, wherein the transformation information is used for aligning the symmetry plane of the first sub-mesh with the global symmetry plane; and
signaling the transformation information.

2. The method of claim 1, wherein the transformation information comprises:
a rotation component, wherein the rotation component comprises three Euler angles; and
a translation component, wherein the translation component comprises a distance for moving the symmetry plane of the first sub-mesh to the global symmetry plane.

3. The method of claim 1, wherein the method further comprises:
coding the first sub-mesh as a part of the symmetric mesh instead of the asymmetric mesh.

4. The method of claim 1, wherein the signaling the transformation information comprises:
signaling a number of sub-meshes that have associated transformation information;
signaling, for each sub-mesh that has associated transformation information, a sub-mesh ID in the symmetric mesh; and
signaling the transformation information.

5. The method of claim 1, wherein when the symmetry plane of the first sub-mesh is parallel to a cardinal plane, the transformation information comprises:
parallel plane index that indicates whether the symmetry plane of the first sub-mesh is parallel to XY plane, YZ plane, or XZ plane; and
a translation component, wherein the translation component comprises a distance for moving the symmetry plane of the first sub-mesh to the global symmetry plane.

6. The method of claim 5, wherein the transformation information is signaled in an order according to one of:
an encoding order;
an order of encoding vertices; or
an order of face numbers of sub-meshes.

7. The method of claim 6, wherein when the transformation information is signaled in the order, a sub-mesh ID of a sub-mesh that has associated transformation information is not signaled.

8. An apparatus for mesh compression, the apparatus comprising:
at least one memory configured to store program code; and
at least one processor configured to read the program code and operate as instructed by the program code, the program code comprising:
partitioning code configured to cause the at least one processor to partition an input mesh into a symmetric mesh and an asymmetric mesh using a global symmetry plane;
first determining code configured to cause the at least one processor to determine one or more sub-meshes in the asymmetric mesh;
second determining code configured to cause the at least one processor to determine, for a first sub-mesh in the asymmetric mesh, whether the first sub-mesh is symmetric;
third determining code configured to cause the at least one processor to determine a symmetry plane for the first sub-mesh when the first sub-mesh is symmetric;
fourth determining code configured to cause the at least one processor to determine transformation information for the first sub-mesh, wherein the transformation information is used for aligning the symmetry plane of the first sub-mesh with the global symmetry plane; and
first signaling code configured to cause the at least one processor to signal the transformation information.

9. The apparatus of claim 8, wherein the transformation information comprises:
a rotation component, wherein the rotation component comprises three Euler angles; and
a translation component, wherein the translation component comprises a distance for moving the symmetry plane of the first sub-mesh to the global symmetry plane.

10. The apparatus of claim 8, wherein the program code further comprises:
encoding code configured to cause the at least one processor to encode the first sub-mesh as a part of the symmetric mesh instead of the asymmetric mesh.

11. The apparatus of claim 8, wherein the first signaling code comprises:
second signaling code configured to cause the at least one processor to signal a number of sub-meshes that have associated transformation information;
third signaling code configured to cause the at least one processor to signal, for each sub-mesh that has associated transformation information, a sub-mesh ID in the symmetric mesh; and
fourth signaling code configured to cause the at least one processor to signal the transformation information.

12. The apparatus of claim 8, wherein when the symmetry plane of the first sub-mesh is parallel to a cardinal plane, the transformation information comprises:
parallel plane index that indicates whether the symmetry plane of the first sub-mesh is parallel to XY plane, YZ plane, or XZ plane; and
a translation component, wherein the translation component comprises a distance for moving the symmetry plane of the first sub-mesh to the global symmetry plane.

13. The apparatus of claim 12, wherein the transformation information is signaled in an order according to one of:
an encoding order;
an order of encoding vertices; or
an order of face numbers of sub-meshes.

14. The apparatus of claim 13, wherein when the transformation information is signaled in the order, a sub-mesh ID of a sub-mesh that has associated transformation information is not signaled.

15. A non-transitory computer-readable medium storing instructions, the instructions comprising: one or more instructions that, when executed by one or more processors of a device for mesh coding, cause the one or more processors to:
partition an input mesh into a symmetric mesh and an asymmetric mesh using a global symmetry plane;
determine one or more sub-meshes in the asymmetric mesh;
for a first sub-mesh in the asymmetric mesh, determine whether the first sub-mesh is symmetric;
determine a symmetry plane for the first sub-mesh when the first sub-mesh is symmetric;
determine transformation information for the first sub-mesh, wherein the transformation information is used for aligning the symmetry plane of the first sub-mesh with the global symmetry plane; and
signal the transformation information.

16. The non-transitory computer-readable medium of claim 15, wherein the transformation information comprises:
a rotation component, wherein the rotation component comprises three Euler angles; and
a translation component, wherein the translation component comprises a distance for moving the symmetry plane of the first sub-mesh to the global symmetry plane.

17. The non-transitory computer-readable medium of claim 15, wherein the one or more instructions that, when executed by one or more processors of a device for mesh coding, further cause the one or more processors to code the first sub-mesh as a part of the symmetric mesh instead of the asymmetric mesh.

18. The non-transitory computer-readable medium of claim 15, wherein the signaling the transformation information comprises:
signaling a number of sub-meshes that have associated transformation information;
signaling, for each sub-mesh that has associated transformation information, a sub-mesh ID in the symmetric mesh; and
signaling the transformation information.

19. The non-transitory computer-readable medium of claim 15, wherein when the symmetry plane of the first sub-mesh is parallel to a cardinal plane, the transformation information comprises:
parallel plane index that indicates whether the symmetry plane of the first sub-mesh is parallel to XY plane, YZ plane, or XZ plane; and
a translation component, wherein the translation component comprises a distance for moving the symmetry plane of the first sub-mesh to the global symmetry plane.

20. The non-transitory computer-readable medium of claim 19, wherein when the transformation information is signaled in an order, a sub-mesh ID of a sub-mesh that has associated transformation information is not signaled.
